(19) United States
(12) Patent Application Publication
(10) Pub. No.: US 2005/0171457 A1
(43) Pub. Date: Aug. 4, 2005

(54) Hair care apparatus and hair treatment process

(76) Inventor: Chih-Yi Yang, Taipei (TW)

Correspondence Address: David I. Roche;BAKER & McKENZIE LLP, 130 E. Randolph Drive, Chicago, IL, 60601, US

(21) Appl. No.: 11/032,626

(22) Filed: Jan. 10, 2005

(30) Foreign Application Priority Data
Jan. 30, 2004 (TW) 093201408

(51) Int. Cl. A61H 7/00

(52) U.S. Cl. 601/11; 601/17

(57) ABSTRACT

A hair care apparatus includes a scalp-treating unit having a sealable hollow interior for accommodating a user's head, a gas-exhaust unit operable to pump air out of the hollow interior of the scalp-treating unit, a cooling unit configured to inject cooled air in the hollow interior of the scalp-treating unit, a dispenser unit configured to dispense a preparation including a hair-vitalizing agent on the scalp, and a controller configured to control the operations of the hair care apparatus. In one embodiment, a hair treatment method includes removing deposits from pores of a scalp, heating the scalp, dispensing a hair-vitalizing agent on the scalp, and cooling down the scalp.

### CROSS-RELATED APPLICATION

This application claims the priority benefit of Taiwan patent application no. 93201408, filed on Jan. 13, 2004.

### FIELD OF THE INVENTION

This invention relates to a hair care apparatus and a hair treatment method implemented to promote hair growth.

### DESCRIPTION OF THE RELATED ART

Thin hair and excessive hair loss are long-existing problems for many people, and find their roots from many causes such as genetic causes, poor nutritive supply to the hair root cells, abnormal sebum secretions, excessive mental stress, etc.

Hair grows from a follicle the lower part of which widens out to form the hair bulb containing the germinal matrix, the source of hair growth. The number of follicles is definitely fixed at the fetus stage. Once the hair follicles degenerate at the adult age, no effective curing treatments are available. Therefore, to remedy hair loss problems, preventive methods are still widely prescribed to stimulate hair growth from the healthy hair follicles and bulbs. In addition, active agents may be applied to retard the follicle degeneration and prevent excessive hair loss.

Japanese Patent No. 3160184, the disclosure of which is incorporated herein by reference, describes a hair care technique by vacuum impregnation. In this technique, a hair care apparatus includes a scalp-treating unit that is placed over the user's head in use, and hermetically covers the user's scalp. Air inside the scalp-treating unit then is pumped out to create vacuum inside the scalp-treating unit to suck out the sebum that might obstruct the scalp pores. In the meantime, a hair care active agent is atomized over the scalp. The vacuum then is removed and the pressure inside the scalp-treating unit sharply increases, which promotes impregnation of the active agent through the scalp pores to vitalize the hair roots.

However, it can be conventionally observed that the external application of active agents is not sufficient to obtain healthy metabolism of the hair root cells, which is essential to recover healthy hair. The blood conveyed through the many vessels proximate to the hair roots under the scalp surface has to constantly circulate to supply the hair root cells with necessary feeding substances. It can be observed that patients with hair loss problems usually have these vessels in an extravasation state with thrombus-like clots, which results in a deficiency of the hair root cell metabolism.

Conventionally, the patient can apply manual massage techniques on the scalp to promote blood circulation. If needed, the user may also use massage tools provided with blunt protrusions to adequately stimulate the scalp areas. However, because the distribution of the blood vessels is relatively complex, these conventional massage techniques usually have limited and only local effects and are not sufficient to meet an effective full-area massage of the scalp.

Therefore, a need presently exists for a hair care apparatus and hair treatment method that can stimulate and promote blood circulation in the scalp vessels and improve hair growth.

### SUMMARY OF THE INVENTION

The present application describes a hair care apparatus and a hair treatment process implemented to stimulate hair growth.

In one embodiment, the hair care apparatus comprises a scalp-treating unit having a sealable hollow interior for accommodating a user's head, a gas-exhaust unit operable to pump air out of the hollow interior of the scalp-treating unit, a cooling unit configured to inject cooled air in the hollow interior of the scalp-treating unit, a dispenser unit configured to dispense a preparation including a hair-vitalizing agent on the scalp, and a controller configured to control the operations of the hair care apparatus.

In some embodiments, the scalp-treating unit includes a screen made of a flexible material having a plurality of holes. The screen is mounted across the hollow interior to contact with the user's head and thereby prevent undesirable contamination of the scalp-treating unit. In another embodiment, the scalp-treating unit comprises a covering member, and an inflatable pressing part connected to a compressed air supply. The covering member and the pressing part are respectively configured to cover and exert a controlled pressure on the user's head.

In an embodiment, a hair treatment process is described. The hair treatment process comprises removing deposits from pores of a scalp, heating the scalp, dispensing a hair-vitalizing agent on the scalp, and cooling down the scalp. In some variations, the hair treatment process further comprises pressing on the user's head to reduce blood circulation to the hair roots while dispensing a hair-vitalizing agent on the scalp.

In some embodiments, the hair treatment process includes heating the scalp while dispensing the hair-vitalizing agent on the scalp. In other embodiments, the hair treatment process includes dispensing the hair-vitalizing agent on the scalp in a depressurized environment.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a schematic view of a scalp-treating unit implemented in a hair care apparatus according to an embodiment of the invention;

FIG. 2 is a schematic view of the placement of the scalp-treating unit on the user's head according to an embodiment of the invention;

FIG. 3 is a schematic view of the scalp-treating unit in a depressurizing state according to an embodiment of the invention;

FIG. 4 is a general schematic view of the hair care apparatus according to an embodiment of the invention;

FIG. 5A˜5C are schematic views illustrating the distribution of atomizing nozzles on an inner surface of the scalp-treating unit according to an embodiment of the invention; and

FIG. 6 is a flowchart of illustrating diverse operating modes of the hair care apparatus according to an embodiment of the invention.

### DETAILED DESCRIPTION OF THE EMBODIMENT(S)

The application describes a hair care apparatus and hair treatment process that can stimulate blood circulation in the scalp blood vessels, activate the metabolism in the hair root cells and promote hair growth.

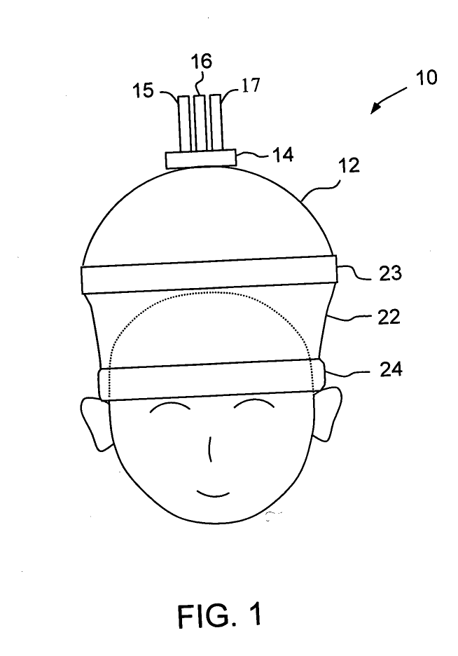

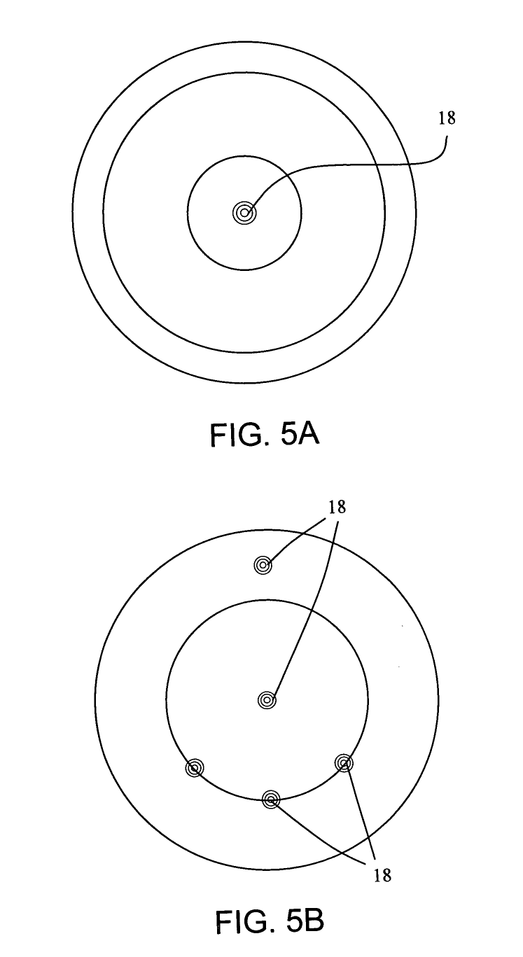

FIG. 1 is a schematic view of the scalp treating unit of a hair care apparatus implemented to stimulate hair growth according to an embodiment of the invention. The scalp-treating unit 10 of the hair care apparatus includes a helmet-like body 12 and a covering member 22. The body 12 is formed in a generally semi-spherical shape, and is made of metal, rigid plastics or like materials capable of sustaining pressure variations. A top of the body 12 is provided with a connector 14 that includes a suction opening 15, an injection opening 16 and an exhaust opening 17. As shown in FIG. 4, the openings 15˜17 connect to the pipes 31˜33.

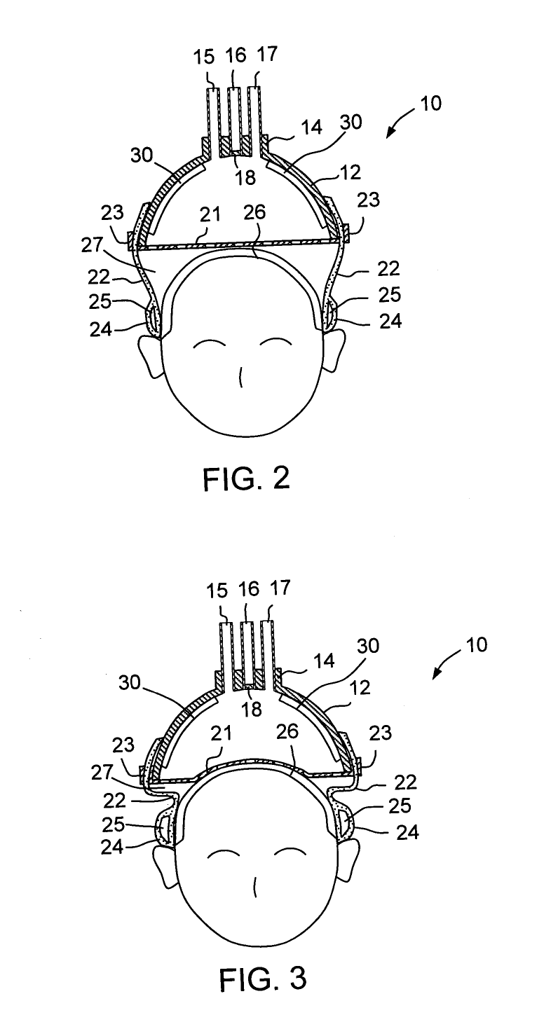

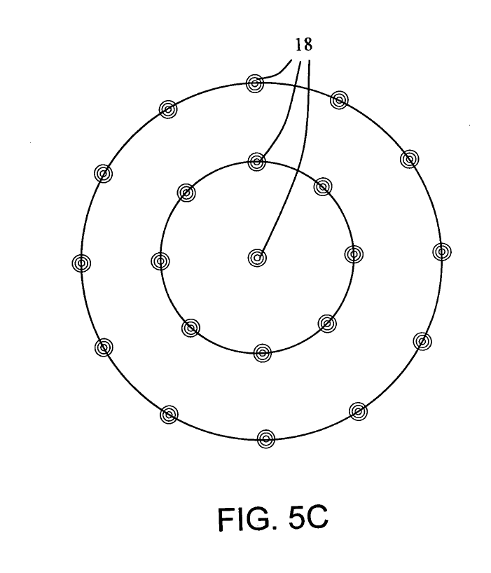

FIG. 2 is a schematic view of the scalp-treating unit put in place over the user's head. The injection opening 16 can receive liquid preparations such as hair-vitalizing agents to be dispensed on the scalp via one or more atomizing nozzle 18. The nozzle 18 connects to the injection opening 16 and is oriented toward the interior of the body 12 where is accommodated the user's head. FIG. 5A˜5C are schematic projection views illustrating the distribution of a plurality of atomizing nozzles on the inner surface of the body 12. The nozzles 18 can be distributed so as to deliver the hair-vitalizing agent at particularly sensitive areas of the scalp such as the occiput, the temples, and the forehead.

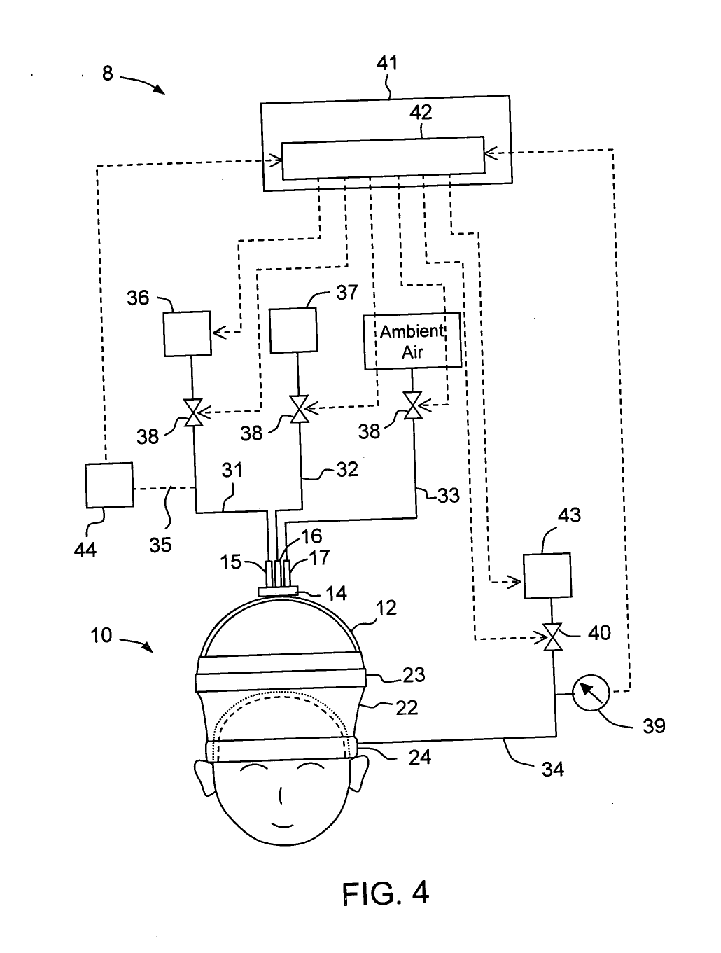

Referring to FIGS. 2 and 3, a flexible screen 21 is mounted across the interior of the body 12. The screen 21 is made of a soft resin, which renders it flexible, and includes holes having diameters between about 5 mm and 25 mm. The screen 21 is fixedly secured to the scalp-treating unit 10 via a metallic clip ring 23. The screen 21 prevents direct contact of the user's head with the inner surface of the scalp-treating unit 10, and ensures that an interior gap 27 remains between the user's head and the inner surface of the body 12 when the scalp-treating unit 10 is installed on the user's head. When being carried, the body 12 rests above the user's head and the screen 21 presses the hairs on the scalp.

The covering member 22 has a generally cylindrical shape and downwardly terminates in a pressing part 24. The covering member 22 is fixedly secured to an external surface of the body 12 via the clip ring 23. The pressing part 24 is made of a flexible material provided with an inner cavity 25. The pressing part 24 has an annular shape to match with the circumference of the head. In an embodiment, the pressing part 24 can be formed integral with the covering member 22.

In use, the scalp-treating unit 10 is installed over the user's head so that the covering member 22 covers the temple regions of the user's head and the pressing part 24 is in contact with a head area above the ears. Upon injection of compressed air in the inner cavity 25, the pressing part 24 inflates and presses against the user's head to seal the interior gap 27 of the scalp-treating unit 10. The inner circumference of the pressing part 24 in a deflated state can be set to accommodate the average size of a male adult head.

A replaceable filter 26 can be applied on the user's head before installation of the scalp-treating unit 10. For each use, a new filter 26 is placed to retain impurities and secretion substances being sucked out from the skin pores. Hygienic use of the scalp-treating unit 10 can be thereby repeatedly ensured, and pollution and damageable clogging of the hair care apparatus is prevented.

A heating device 30 is mounted on an inner surface of the body 12. In an embodiment, the heating device 30 can be in the form of a single integral, or assembly of many infrared heating plate(s) laid on the inner surface of the body 12. In another embodiment not illustrated, the heating device 30 can further include a blowing device or fan (not shown) integrated in the scalp-treating unit 10.

FIG. 4 is a general schematic view of the hair care apparatus according to an embodiment of the invention. In the hair care apparatus 8, the scalp-treating unit 10 is connected to a gas exhaust unit 36, a container 37 storing a preparation composed of hair active agents, a compressed air supply 43, a cooling unit 44 and a controller 41, respectively. The controller 41 incorporates a control interface 42.

The gas-exhaust unit 36 is operable to pump out gas from the interior gap 27 of the scalp-treating unit 10 via an exhaust pipe 31. The hair-vitalizing agents stored inside the container 37 can be atomized on the scalp via the nozzles 18 connected to principal supply pipe 32 and auxiliary supply pipes (not shown). External ambient air is conveyed to the interior gap 27 of the scalp-treating unit 10 via a gas inlet pipe 33. Valves 38 are respectively connected to the pipes 31, 32, 33 to control air supply and air removal of the scalp-treating unit 10.

Air pressure is injected through a pressure supply pipe 34 into the inner cavity 25 of the pressing part 24. A pressure gauge 39 and a three-way valve 40 mounted on the pressure supply pipe 34 respectively connect to a control interface 42 of the controller 41 to control and regulate the air pressure supplied to the pressing part 24. The compressed air supply 43 can take any forms, such as compressed air cylinders, an air compressor, or the like. A cooling pipe 35 conveys cooling air generated at the cooling unit 44 into the scalp-treating unit 10.

The controller 41 can include various components such as a central processor, RAM, ROM, a storage device and like computer components. The control interface 42 is coupled with the gas-exhaust unit 36, the valves 38, the compressed air supply 43 and the valve 40. The controller 41 includes a user interface that allows a human operator to command via the control interface 42 the operation of the hair care apparatus. The controller 41 is programmable to control the operation of the hair care apparatus in different modes as described below.

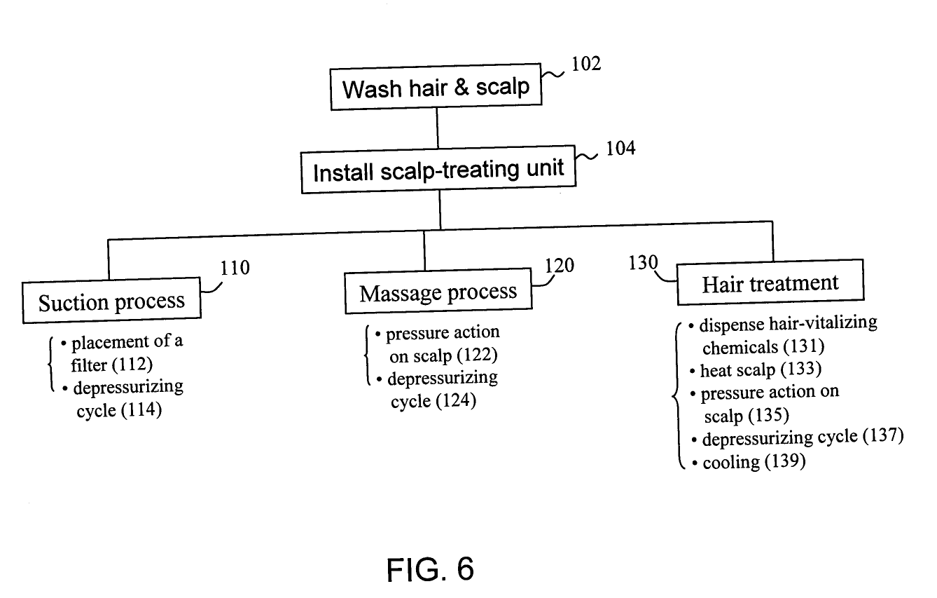

FIG. 6 is a flowchart illustrating various operating modes of the hair care apparatus implemented in a hair treatment method according to an embodiment of the invention. Initially, the user's hair is washed to remove impurities and clean the scalp (102). A shampoo including cleansing agents can be used in accordance with the type of skin so as to ensure proper hair and scalp cleaning. The hair then is dried.

Subsequently, the scalp-treating unit is put in place over the user's head (104). The scalp-treating unit 10 is installed on the user's head. As shown in FIG. 2, the scalp-treating unit 10 stands over the user's head with an interior gap 27 defined between the user's head and the inner surface of the scalp-treating unit 10, while the covering member 22 and the pressing part 24 are in contact with the temple regions.

The compressed air supply 43 then is operated to inject air into the inner cavity 25 of the pressing part 24. As a result, the pressing part 24 inflates to press against the user's head, which seals the interior gap 27 between the user's head and the inner surface of the scalp-treating unit. Once the interior gap 27 of the scalp-treating unit 10 is sealed, the hair care apparatus can be activated for hair and scalp treatment.

As shown in FIG. 6, one operating mode of the hair care apparatus can include conducting a suction process to remove the sebum and other deposits from the scalp pores (110). To this purpose, a filter 26 is interposed between the user's head and the screen 21 while the scalp-treating unit is put in place (112). The suction process applies one or more cycle of pressure variation, also called “depressurizing cycle”, to the interior gap of the scalp-treating unit (114). One depressurizing cycle includes at least one phase of pressure decrease (or depressurizing phase) in which air in the interior gap of the scalp-treating unit 10 is pumped out, and one phase of pressure increase in which air is allowed to enter the interior gap of the scalp-treating unit to recover a normal atmospheric pressure condition. During the depressurizing phase, the undesirable deposits on the scalp are sucked out and retained by the filter 26. After the depressurizing phase, external air is allowed to penetrate in the interior of the scalp-treating unit by releasing the pressing action from the pressing part 24. The depressurizing cycle can be repeated a number of times to ensure that undesirable deposits on the scalp are substantially removed. Once the suction process is completed, the filter 26 is removed. A cleansing agent can be further applied to the scalp to ensure that the scalp is completely clean.

Another operating mode according to an embodiment of the invention includes a massage process in which the scalp is stimulated by pressure application to improve scalp blood circulation (120). To this purpose, the compressed air supply 43 is operated to inject air in the pressing part 24 that consequently inflates to press against the head. The pressure exerted by the pressing part 24 is controlled to create a temporary state of reduced blood circulation in the scalp blood vessels (122).

While the pressing part presses against the user's head and thereby seals the interior gap, one or more cycle of depressurizing pressure can be applied to the interior gap of the scalp-treating unit (124). Air inside the scalp-treating unit 10 is exhausted so as to decrease the pressure in the interior gap 27 of the scalp-treating unit 10. As shown in FIG. 3, the screen 21 accordingly deforms to press against the head contour. Once the inner pressure inside the scalp-treating unit 10 is reduced to a target value, the pressing action from the pressing part 24 is released so that the interior of the scalp-treating unit 10 progressively recovers the external ambient pressure. The foregoing cycle can be repeated a number of times to stimulate blood circulation in the scalp blood vessels.

Another operating mode according to an embodiment of the invention includes a hair treatment process by vitalizing agent impregnation (130). This operating mode includes applying one or more depressurizing cycle to the interior gap of the scalp-treating unit (137) accompanied with timely dispensing hair-vitalizing agents on the scalp (131). One depressurizing cycle includes at least a phase of pressure decrease and a phase of pressure increase. Once the desired low-pressure level is reached in the pressure decrease phase, a liquid preparation including water and one or more hair-vitalizing agent is atomized in fine droplets over the scalp.

To promote the impregnation of the hair-vitalizing agent, the scalp can be put in heated environment by activating the heating device to elevate the temperature inside the interior gap of the scalp-treating unit (133). In an embodiment, the heating effect can be obtained from the combined actions of heating elements and a fan to uniformly distribute heat inside the scalp-treating unit 10.

Additionally, the pressure exerted by the pressing part can be controlled to reduce blood circulation to the hair roots (135) while the hair-vitalizing agent is dispensed over the scalp. Reduced blood circulation also contributes to improve impregnation of the hair-vitalizing agent. The heating/pressure action applied on the scalp can be conducted either independently or in combination with the depressurizing cycle while the hair-vitalizing agent is dispensed over the scalp.

After dispensing the hair-vitalizing agent is completed, the cooling unit is activated to generate a cooling airflow in the scalp-treating unit (139). This cooling stage causes scalp pore constriction once the hair-vitalizing agent is impregnated in the scalp, which can enhance the action of the hair-vitalizing agent on the scalp.

During the hair treatment process (130), any of the steps (131), (133), (135) (137) and (139) can be repeated one or more times, either independently or in combination, to stimulate blood circulation and increase the impregnation of the hair-vitalizing agents deep in the scalp. For example, the application of the hair-vitalizing agents, the heating process and the cooling process can be performed either at each depressurizing cycle or at specific intervals of depressurizing cycles to optimize the hair treatment method. In another example of implementation, one single cooling step (139) can be conducted at the end of a hair treatment process instead of being cyclically repeated.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components and operations are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

1. A hair care apparatus, comprising:
a scalp-treating unit having a sealable hollow interior configured to mount on a user's head, and a plurality of nozzles communicating with the hollow interior of the scalp-treating unit;
a heating device mounted to the scalp-treating unit and configured to heat the hollow interior of the scalp-treating unit;
a gas-exhaust unit mounted to the scalp-treating unit, wherein the gas-exhaust unit is operable to pump air out of the hollow interior of the scalp-treating unit;
a cooling unit configured to inject cooled air in the hollow interior of the scalp-treating unit;
a dispenser unit configured to dispense a preparation including a hair-vitalizing agent on the scalp; and
a controller, configured to control the operations of the heating device, the gas-exhaust unit, the cooling unit and the dispenser unit, respectively.

2. The hair care apparatus according to claim 1, wherein the scalp-treating unit includes a screen made of a flexible material having a plurality of holes, the screen is mounted across the hollow interior to contact with the user's head.

5. The hair care apparatus according to claim 1, wherein the scalp-treating unit comprises:
a covering member; and
an inflatable pressing part connected to a compressed air supply, wherein the covering member and the pressing part are configured to cover and press on the user's head.

6. The hair care apparatus according to claim 1, wherein the controller is programmable to conduct a hair treatment process including:
sucking out deposits from pores of the scalp; and
dispensing the hair-vitalizing agent on the scalp.

7. The hair care apparatus according to claim 6, wherein the controller is programmable to heat the hollow interior of the scalp-treating unit while dispensing the hair-vitalizing agent on the scalp.

8. The hair care apparatus according to claim 6, wherein the controller is programmable to cool down the hollow interior of the scalp-treating unit after dispensing the hair-vitalizing agent on the scalp.

9. The hair care apparatus according to claim 6, wherein the controller is programmable to keep the hollow interior of the scalp-treating unit in a depressurized state while dispensing the hair-vitalizing agent on the scalp.

10. The hair care apparatus according to claim 9, wherein the controller is further programmable to heat the scalp while dispensing the hair-vitalizing agent on the scalp in the depressurized state.

11. The hair care apparatus according to claim 5, wherein the controller is programmable to dispense a hair-vitalizing agent on the scalp while the pressing part tightly presses on the user's head to reduce blood circulation.

12. The hair care apparatus according to claim 6, wherein a filter is interposed between the screen and the user's head while sucking out deposits from the scalp pores.

13. The hair care apparatus according to claim 6, wherein dispensing the hair-vitalizing agent on the scalp includes atomizing the hair-vitalizing agent in fine droplets from the nozzles of the scalp-treating unit.

14. A hair treatment process comprising:
removing deposits from pores of a scalp;
heating the scalp;
dispensing a hair-vitalizing agent on the scalp; and
cooling down the scalp.

15. The hair treatment process according to claim 14, further comprising pressing on the user's scalp to reduce blood circulation while dispensing a hair-vitalizing agent on the scalp.

16. The hair treatment process according to claim 14, wherein dispensing a hair-vitalizing agent on the scalp includes atomizing the hair-vitalizing agent in fine droplets on the scalp.

17. The hair treatment process according to claim 14, further comprising keeping the scalp in a depressurized environment while dispensing the hair-vitalizing agent on the scalp.

18. The hair treatment process according to claim 17, wherein heating the scalp is performed while dispensing the hair-vitalizing agent on the scalp in the depressurized environment.
